(19) United States
(12) Patent Application Publication
(10) Pub. No.: US 2026/0135450 A1
(43) Pub. Date: May 14, 2026

(54) DEVICE FOR JOINING ELONGATE COMPONENT REGIONS OF WINDING ELEMENTS OF AT LEAST ONE WINDING OF AN ELECTRIC MACHINE, AND USE OF SUCH A DEVICE

(71) Applicant: MERCEDES-BENZ GROUP AG, Stuttgart (DE)

(72) Inventor: Dirk STEFFENS, Weinstadt (DE)

(21) Appl. No.: 19/121,467

(22) PCT Filed: Oct. 12, 2023
(86) PCT No.: PCT/EP2023/078421

§ 371 Date: Apr. 16, 2025

(30) Foreign Application Priority Data
Oct. 17, 2022 (DE) 10 2022 003 824.2

(51) Int. Cl. H02K 15/35; H01F 41/04

(52) U.S. Cl. CPC H02K 15/35; H01F 41/04

(57) ABSTRACT

A device for joining elongate component regions of winding elements of at least one winding of an electric machine is provided. The device has a first tool part with a recess that is conical and thus tapers in an extension direction, and a second tool part, which has a main part and two clamping fingers that are mutually spaced along a spacing direction extending perpendicularly to the extension direction, are held on the main part so as to be able to pivot relative to the main part about a respective pivot axis extending perpendicularly to the extension direction and perpendicularly to the spacing direction, and can be moved and can thereby be pivoted towards to one another in the extension direction into the recess in order to clamp the elongate component regions between the clamping fingers.

### BACKGROUND AND SUMMARY OF THE INVENTION

Exemplary embodiments of the invention relate to a device for joining elongate component regions of winding elements of at least one winding of an electric machine, as well as to the use of such a device.

JP 2014-7794 A1, JP 2014-7795 A1, and JP 2014-183623 A disclose electric machines with respective windings that have respective winding elements, i.e., are formed by the winding elements. In this case, respective elongate component regions of the respective winding elements are welded to one another and thus connected to one another, i.e., joined to one another.

Furthermore, WO 2020/210855 A1 discloses a method for positioning a laser beam during the welding of electrical conductors of an electric component.

Exemplary embodiments of the present invention are directed to a device and the use of such a device, so that elongate component regions of winding elements of at least one winding of an electric machine can be joined to one another particularly advantageously.

A first aspect of the invention relates to a device for joining, in particular pin-like, elongate component regions of winding elements of at least one winding of an electric machine. The feature that the elongate component regions are, for example, pin-like and therefore pin-shaped, is to be understood to mean, in particular, that the respective elongate component region extends along its respective longitudinal extension direction in an elongated manner and thus, for example, linearly and like a line and in in particular in a straight line. The respective elongate component region is a constituent part of a respective component, which is the respective winding element. In particular, elongate component regions themselves can be understood as respective components joined to one another, i.e., are welded to one another. In particular, the components or the winding elements are designed separately from one another, with the components or the winding elements being joined to one another. By way of example, the components or winding elements are welded to one another and thereby connected to one another, in particular by laser beam welding.

In particular, the winding elements are plug-in coils, in particular with a respective U-shaped geometry, and the plug-in coils are also referred to as hairpins. In this case, the at least one winding is constructed and therefore assembled from the plug-in coils in accordance with what is known as hairpin technology. For example, the respective elongate component region is a respective limb of the respective U-shaped geometry.

In order to be able to precisely align the elongate component regions relative to one another in a particularly simple and process-reliable manner and to fix them permanently relative to one another, and in particular to one another, so that the elongate component regions can be joined and therefore connected to one another, for example by welding, in particular laser beam welding, particularly advantageously and in a process-reliable manner, the device—also referred to as a tool and designed, for example, as a chuck or clamping tool or functioning as a chuck or clamping tool—has a first tool part, which is also referred to as a first tool half. The first tool part has a recess which, in particular on the inner circumference thereof, has a conical design and as a result tapers in an extension direction. The device also has a second tool part, which is also referred to as a second tool half. The second tool part has a main part and two clamping fingers, also referred to as tensioning fingers or clamping pins, which, for example, project from the main part in the extension direction. The clamping fingers are mutually spaced along a spacing direction extending perpendicularly to the extension direction. The respective clamping finger is held on the main part so as to be able to pivot relative to the main part about a respective pivot axis, with the pivot axes being mutually spaced along the spacing direction. The respective pivot axis extends perpendicularly to the extension direction and perpendicularly to the spacing direction. In other words, for example, the extension direction and the spacing direction span an extension plane, and the respective pivot axis extends perpendicularly to the extension plane. The clamping fingers can be moved into the recess, in particular as a result of the second tool part being moved in the extension direction relative to the first tool part, in particular translationally. By moving the clamping fingers into the recess, in particular in the extension direction, the clamping fingers can be pivoted about the pivot axes relative to the main part in such a way that the clamping fingers can be pivoted towards one another. As a result, the elongate component regions, which are or can be arranged between the clamping fingers in particular along the spacing direction and which are or can be arranged successively in particular along the spacing direction, are or will be clamped between the clamping fingers and in particular pressed against one another and subsequently fixed relative to one another.

In addition, the elongate component regions are moved relative to one another and in the process, in particular, towards one another by the clamping fingers being pivoted towards one another while the elongate component regions are arranged in particular along the spacing direction between the clamping fingers, for example when the elongate component regions first have an offset with respect to one another and as a result are brought into an advantageous joining position, in which the elongate component regions are held by means of the clamping fingers, in particular, clamping the elongate component regions. In the joining position, elongate component regions have an advantageous location, positioning or alignment relative to one another, so that the elongate component regions can subsequently be joined to one another, in particular welded to one another, in a process-reliable manner and thereby joined to one another. In particular, for example, the elongate component regions are also electrically conductively connected to one another by the elongate component regions being joined to one another, so that the invention enables a precise and process-reliable as well as fast and cost-effective mechanical and electrical connection of the elongate component regions to one another.

The first tool part is designed, for example, as an, in particular solid, C bracket, into the recess of which the pivotable, i.e., rotatable clamping fingers can be moved. Since the clamping fingers are rotatable about the pivot axes relative to the main part, the clamping pins are movable. By means of a corresponding travel of the tool parts in such a way that the clamping pins are moved into the recess, the clamping pins (clamping fingers) are moved together, i.e., pivoted towards one another, whereby, for example, the clamping fingers pick up the elongate component regions to be joined and in the process in particular align them relative to one another and fix them to one another. By way of example, due to a conical shaping of the clamping fingers, the latter push or turn together as travel progresses along the C bracket in such a way that they bring the elongate component regions into their joining position, also referred to as end position, and permanently fix the elongate component regions in the joining position, in particular without or with as small a gap as possible between the elongate component regions and without or with as little twisting as possible of the elongate component regions. In particular, it is conceivable that the tool parts and the clamping fingers are matched to one another in terms of their angles in order to realize an advantageous clamping function, in the context of which the elongate component regions can be particularly advantageously clamped, that is to say tensioned and thereby precisely positioned and fixed relative to one another, in particular fixed to one another, by means of the device. The tool parts can, for example, be mechanically secured and therefore in particular fixed relative to one another via at least one or more axles, via at least one or more motors and/or by at least one or more other devices, in order to thereby advantageously be able to fix elongate component regions relative to one another during the joining of the elongate component regions. Furthermore, the device can be used as a single-cavity or multi-cavity mold, for example.

The invention is based in particular on the following findings and considerations: according to the current state of the art, plug-in coils—also referred to as hairpins—for electric machines, in particular for electric motors, are connected to one another, i.e., joined to one another, by means of laser beam welding. For this purpose, it is advantageous to position the plug-in coils, in particular the elongate component regions of the plug-in coils, exactly relative to one another, so that faulty welded connections due to a possible gap, possible twisting, etc. can be avoided. With regard to designs of the electric machine, a distinction is made, inter alia, between radial flux machines and axial flux machines. In particular, as a result of restricted installation space, the design of axial flux machines means that clamping tools have very restricted access to fix the elongate component regions relative to one another during their joining. The device according to the invention now makes it possible to be able to fix the elongate component regions, while they are being joined, in particular relative to one another, even if there is only limited or restricted access to the elongate component regions.

A second aspect of the invention relates to the use of a device in accordance with the first aspect of the invention, wherein the device is used to join elongate component regions of winding elements, designed in particular as plug-in coils, of at least one winding of an electric machine to one another. In particular, the elongate component regions are fixed relative to one another, and in particular to one another, by means of the device, while the elongate component regions are joined to one another, in particular welded to one another and thereby joined to one another. Advantages and advantageous configurations of the first aspect of the invention are to be regarded as advantages and advantageous configurations of the second aspect of the invention and vice versa.

The clamping fingers are arranged in the recess in such a way, for example, that they push tool parts, also referred to or designed as claws, towards one another and thus together. Because the clamping fingers are pivoted towards one another as a result of the clamping fingers moving into the recess, the clamping fingers exert a clamping force on the elongate component regions arranged along the spacing direction between the clamping fingers and following one after the other along the spacing direction, which clamping force extends along the spacing direction and thus orthogonally to the extension direction. It is also conceivable that by pushing the tool parts together, the elongate component regions are clamped between the tool parts or supported on the tool parts along a clamping direction coinciding with the extension direction, so that the elongate component regions are not only clamped between the tool parts along the spacing direction, but also along the clamping direction, and thus precisely and permanently fixed relative to one another or fixed to one another. If the elongate component regions, designed as webs for example, are initially positioned relative to one another or not positioned in such a way that the elongate component regions are initially offset from one another, then elongate component regions, due to the arrangement thereof between the clamping fingers and in the recess, are therefore moved relative to one another by pushing the tool parts together and thus advantageously and precisely aligned relative to one another in such a way that the elongate component regions are moved into the joining position. By means of the tool parts, the elongate component regions are held in the joining position, in particular the elongate component regions are joined to one another. In particular, the tool according to the invention makes it possible to move and to position the elongate component regions both along the spacing direction and along the clamping direction, with the spacing direction and the clamping direction being perpendicular to one another. The elongate component regions can then, for example, be securely and fixedly connected to one another by laser welding, i.e., joined to one another. Simple laser welding can also be enabled in this case by good positioning of the elongate component regions, in particular of free ends of the elongate component regions, relative to one another in order to be able to weld in a process-reliable and operationally safe manner.

The respective elongate component region has, for example, an at least substantially rectangular cross section, wherein, for example, the elongate component region or its cross sections are parallel to one another in the joining position. Subsequently, for example, the elongate component regions, in particular cross sections, clamped between the tool parts form an overall rectangular shape.

Preferably, the clamping fingers, also referred to as arms or clamping arms, are of conical design, in particular on the outside or outer circumference, so that they have on the outside or outer circumference the shape of a cone or truncated cone with a first angle, the first angle of which, for example, is matched to a second angle of the conical recess, and thus corresponds to the second. This results, when pressing the clamping fingers and thus the elongate component regions together and thus when the clamping fingers interact with the elongate component regions, at least substantially in a rectangular shape in the device, in such a way that inner sides of the clamping fingers bear flat against outer sides of the elongate component regions, with the respective inner side and the respective outer side lying in a plane which, for example, extends parallel to the extension direction.

In particular, in the embodiment of the electric machine or of the elongate component regions, in particular the ends thereof, the device designed or functioning as a clamping device can interact directly laterally or via angularly disposed clamping jaws with the elongate component regions, with a force direction for example always acting laterally to the ends of the elongate component regions. Thus the elongate component regions can be clamped even if welding sites are not accessible from the side.

In the state in which the clamping fingers are pivoted towards one another, a restoring force acts on the fingers for example, which, in particular, is a restoring spring force that is provided by a restoring spring, for example. If, for example, the tool parts are then pushed apart, i.e., moved away from one another, then, for example, the clamping fingers are pivoted away from one another by means of the restoring force and opened as a result, whereby, for example, the clamping fingers are rotated into a starting position, from which the clamping fingers are then pivoted back towards one another when the clamping fingers are moved into the recess. Therefore, the device can easily be used quickly and cost-effectively for the repeated, successive clamping of respective elongate component regions.

In particular, at least the following advantages can be realized by the invention:
particularly suitable for the laser beam welding of plug-in coils (hairpins) of an axial flux machine
very good and exact placement of the elongate component regions to be joined, thus advantageous welding conditions
reduction in component waste
compensation for both lateral offset of the elongate component regions and twisting possible
only little accessibility required
new design possibilities
flexible application to or for both axial flux machines and radial flux machines
especially suitable for welding connections in small quantities
fixing of two or more elongate component regions or plug-in coils possible

Further advantages, features and details of the invention will become apparent from the following description of a preferred exemplary embodiment and with reference to the drawing. The features and feature combinations mentioned above in the description and the features and feature combinations mentioned hereinafter in the description of the figures and/or shown alone in the figures can be used not only in the respectively given combination, but also in other combinations or in in isolation, without departing from the scope of the invention.

### BRIEF DESCRIPTION OF THE DRAWING FIGURES

The drawing shows in:

FIG. 1 a schematic plan view of a device for joining elongate component regions of winding elements of at least one winding of an electric machine;

FIG. 2 a further schematic plan view of the device; and

FIG. 3 schematic side views of the device.

In the figures, the same or functionally identical elements are given the same reference signs.

### DETAILED DESCRIPTION

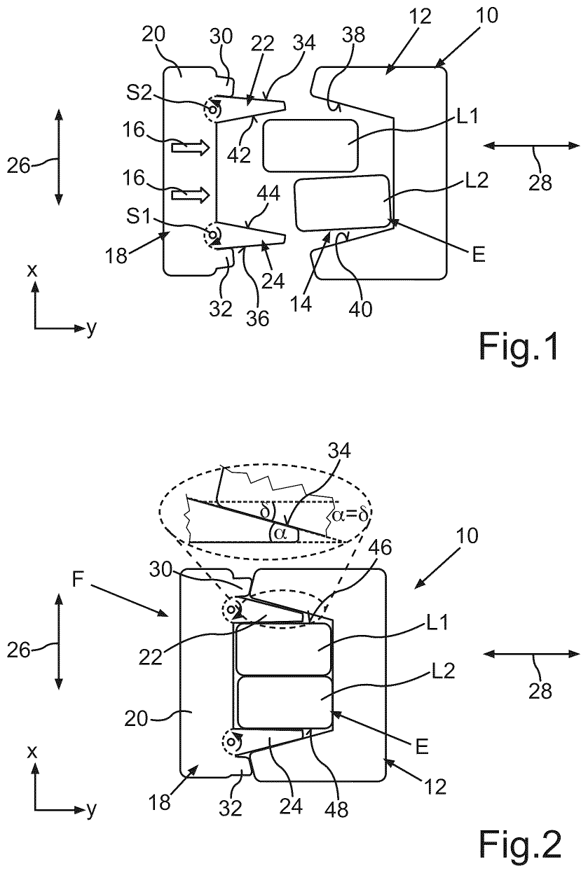

FIG. 1 shows a schematic plan view of a device 10, also referred to as a tool and designed or functioning, for example, as a clamping tool or chuck, for joining elongate component regions L1 and L2 of winding elements of at least one winding of an electric machine. The respective winding element is, for example, a plug-in coil, which is also referred to as a hairpin. The at least one winding of the electric machine is constructed and thus formed, for example, in accordance with what is known as hairpin technology from the plug-in coils (hairpins). In this case, for example, the elongate component region L1 is an elongate component region of a first of the winding elements, and the elongate component region L2 is an elongate component region of a second of the winding elements. The first winding element and the second winding element are designed separately from one another, with the elongate component regions L1 and L2 and thus the first winding element and the second winding element being joined to one another, i.e., connected to one another. By way of example, the elongate component regions L1 and L2 are welded to one another and are thereby mechanically as well as electrically connected to one another. The elongate component regions L1 and L2 are welded, for example, by laser welding, i.e., by laser beam welding. As will be explained in more detail hereinafter, the device 10 is used during the joining of the elongate component regions L1 and L2, in particular during the joining of the elongate component regions L1 and L2, in order to fix the elongate component regions L1 and L2 relative to one another and in the process in particular to one another.

It can be seen from FIG. 1 that the elongate component regions L1 and L2, the respective, free ends of which are labelled with E, initially have an offset from one another. As will be explained in more detail hereinafter, the elongate component regions L1 and L2 are positioned relative to one another, i.e., aligned relative to one another, with the device 10. For this, the elongate component regions L1 and L2, in particular their free ends E, are moved by means of the device 10 relative to one another and thereby into a joining position F shown in FIG. 2. The elongate component regions L1 and L2 assume the joining position F while they are being connected to one another, with the elongate component regions L1 and L2 being held by means of the tool (device 10) in the joining position F.

The device 10 has a first tool part 12 which has a recess 14. The recess 14 has a conical design on the inside, i.e., on the inner circumference, such that the recess 14 tapers in an extension direction illustrated in FIG. 1 by arrows 16.

The device 10 has a second tool part 18, which has a main part 20 and two clamping fingers 22 and 24. The clamping fingers 22, 24 are also referred to as arms, clamping arms, or clamping pins. The respective clamping finger 22, 24 is held on the main part 20 so as to able to pivot about a respective pivot axis S1, S2 relative to the main part 20. It can be seen that the clamping fingers 22 and 24 are mutually spaced along a spacing direction illustrated by a double-headed arrow 26, and the pivot axes S1 and S2 are mutually spaced along the spacing direction. In FIG. 1, a double-headed arrow 28 illustrates a clamping direction also referred to as fixing direction, which coincides with the extension direction. Along the spacing direction, a respective, outer stop 30, 32 adjoins the respective clamping fingers 22, 24, which will be explained in more detail hereinafter. In addition, spatial directions extending pairwise perpendicularly to one another are labelled with x, y and z in the figures.

In the exemplary embodiment shown in the figures, the first tool part 12, also referred to as first tool half, is designed as a solid C bracket. It can be seen from FIGS. 1 and 2 that the elongate component regions L1 and L2 are arranged in the recess 14 for example. The elongate component regions L1 and L2 are also arranged between the clamping fingers 22 and 24, in particular such that the elongate component regions L1 and L2 are arranged along the spacing direction between the clamping fingers 22, 24 and along the spacing direction in succession. In particular, the tool parts 12 and 18 are then to be moved along the clamping direction towards one another, in particular pushed together, in such a way that the clamping fingers 22 and 24 are moved in the extension direction into the recess 14. In the process, respective outer faces 34 and 36, facing away from each other in the spacing direction, of the clamping fingers 22 and 24 slide on respective inner faces 38 and 40 of the tool part 12, in particular directly, with the inner faces 38 and 40 being mutually spaced along the spacing direction and delimiting the recess 14, in particular directly. The respective inner face 38, 40 extends in a respective inner face plane, wherein the inner face plane extends parallel to the respective pivot axis S1, S2 and obliquely to the spacing direction and obliquely to the extension direction and thus obliquely to the clamping direction. In addition, the inner face planes extend towards one another as viewed in the extension direction.

FIG. 1 shows the clamping fingers 22 and 24 in a respective starting position of the clamping fingers 22 and 24. In the starting position, the outer faces 34 and 36 are supported on the stops 30 and 32. The respective clamping fingers 22, 24 also has a conical design, in the present case such that the respective clamping finger 22, 24 has the respective outer face 34, 36 and a respective, further inner face 42, 44. The respective outer face 34, 36 and the respective inner face 42, 44 of the respective clamping fingers 22, 24 form a respective pair of faces, with the respective outer face 34, 36 and the respective inner face 42, 44 of the respective pair of faces also being referred to as surfaces. It can be seen that the surfaces the pair of faces extend in respective surface planes in such a way that the respective outer face 34, 36 extends in a respective first one of the surface planes and the respective inner face 42, 44 extends in a respective, second one of the surface planes. The surface planes of the respective pair of faces extend parallel to the respective pivot axis S1 and S2 and obliquely to the extension direction and obliquely to the clamping direction, in such a way that the respective surface planes of the respective pair of faces extend towards one another in the extension direction. In this case, for example, the inner face plane encloses a first angle with the extension direction or with the clamping direction a first angle, and in the starting position, for example, the respective second surface plane encloses a second angle with the extension direction, with the first angle and the second angle preferably being the same, i.e. the second angle corresponds to the first angle.

It can be seen from FIG. 2 that by pushing the tool parts 12 and 18 together and the resulting movement of the clamping fingers 22, 24 in the recess 14, the outer faces 34 and 36 come into supporting contact with the inner faces 38 and 40 and the inner faces 42 and 44 come into, direct, supporting contact with corresponding, further outer faces 46 and 48 of the elongate component regions L1 and L2. Thus, FIG. 2 shows a state in which the outer faces 34, 36 bear, in particular directly, on the inner faces 38 and 40 and the inner faces 42 and 44 bear, in particular directly, on the outer faces 46 and 48. In this state, the clamping fingers 22 and 24 are in a clamping position that is different from the starting position. In the clamping position, the second surface planes extend parallel to each other and parallel to the extension direction and thus parallel to the clamping direction. The first surface planes extend obliquely to each other and obliquely to the extension direction and obliquely to the clamping direction and parallel to the respective pivot axis S1 and S2 in such a way that the second surface planes extend towards one another in the extension direction, just like the inner face planes.

It can be seen from FIG. 2 that in the in FIG. 2 shown state, in which the outer faces 34 and 36 bear directly on the inner faces 38 and 40 directly delimiting the recess 14 along the spacing direction and mutually spaced along the spacing direction, the respective, second surface plane and thus the respective outer face 34, 36 encloses a respective, first angle α with a plane, also referred to as extension plane, extending parallel to the extension direction and thus parallel to the clamping direction, and the respective inner face plane and thus the respective inner face 38, 40 encloses a respective, second angle δ with the extension plane, where the angle α corresponds to the angle δ. By way of example, the angle α is the aforementioned first angle and, by way of example, the angle δ is the aforementioned second angle. Moreover, for example, in the state shown in FIG. 2, the elongate component regions L1 and L2 are supported along the clamping direction, in particular directly, on the tool parts 12 and 18 so that in that state, the elongate component regions L1 and L2 are clamped between the tool parts 12 and 18 and by means of the tool parts 12 and 18 not only along the spacing direction (double-headed arrow 26), but also along clamping direction (double-headed arrow 28) that is perpendicular to the spacing direction, and are thereby fixed relative to one another. In this state, the elongate component regions L1 and L2 assume the joining position F in which the elongate component regions L1 and L2 are joined to one another, in particular are welded to one another.

The respective clamping fingers 22, 24 can be assigned a retaining spring which, when the clamping fingers 22 and 24 are pivoted out of the starting position towards one another, is braced and subsequently provides a restoring force in the form of a resilient force, by means of which, for example, when the tool parts 12 and 18 are moved away from one another, the respective clamping finger 22, 24 is pivoted back relative to the main part 20, in particular until the respective clamping finger 22, 24 comes into supporting contact with the respective, associated stop 30, 32.

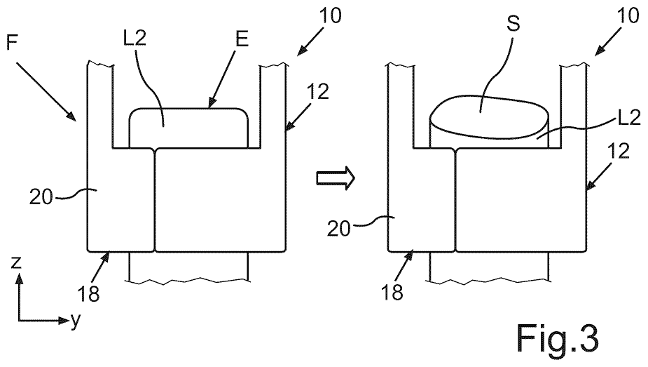

FIG. 3 shows the device 10 and the elongate component regions L1 and L2 in the state shown in FIG. 2. While the elongate component regions L1 and L2 are in the joining position F, welding is carried out, in particular in the form of laser welding, by means of which the elongate component regions L1 and L2 are connected to one another in particular mechanically and electrically. In this case, in particular, the free ends E of the elongate component regions L1 and L2 are melted and fused to one another in the joining position F, which is then shown with the melt S in FIG. 3.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE SIGNS

10 device
12 first tool part
14 recess
16 arrow
18 second tool part
20 main part
22 clamping fingers
24 clamping fingers
26 double-headed arrow
28 double-headed arrow
30 stop
32 stop
34 outer face
36 outer face
38 inner face
40 inner face
42 further inner face
44 further inner face
46 further outer face
48 further outer face
E end
F joining position
L1 elongate component region
L2 elongate component region
S melt
S1 pivot axis
S2 pivot axis
x spatial direction
y spatial direction
z spatial direction
α angle
δ angle

1-5. (canceled)

6. A device configured to join elongate component regions of winding elements of at least one winding of an electric machine, the device comprising:
a first tool part with a recess that is conical and tapers in an extension direction; and
a second tool part having a main part and two clamping fingers, wherein the two clamping fingers are mutually spaced along a spacing direction extending perpendicularly to the extension direction, are held on the main part so as to be able to pivot relative to the main part about a respective pivot axis extending perpendicularly to the extension direction and perpendicularly to the spacing direction, and are movable to pivot towards one another in the extension direction into the recess to clamp the elongate component regions between the clamping fingers.

7. The device of claim 6, wherein, in a state in which outer faces of the two clamping fingers bear directly on inner faces of the first tool part that delimit the recess and are mutually spaced along the spacing direction, the respective outer face encloses, with a plane extending parallel to the extension direction and parallel to the respective pivot axis, a respective first angle and the respective inner face encloses, with the plane, a respective second angle corresponding to the respective first angle.

8. The device of claim 6, further comprising:
a drive configured to move the two clamping fingers into the recess.

9. The device of claim 6, further comprising:
a fixing apparatus configured to fix the first and second tool parts relative to one another.

10. A method for joining elongate component regions of winding elements of at least one winding of an electric machine to one another, the method comprising:
placing the elongate component regions in a recess of a first tool part, wherein the recess conical and tapers in an extension direction;
moving the first tool part towards a second tool part or the second tool part towards the first tool part so that two clamping fingers of the second tool part slide against an inner portion of the recess and align and clamp the elongate component regions, wherein the second tool part has a main part and the two clamping fingers, wherein the two clamping fingers are mutually spaced along a spacing direction extending perpendicularly to the extension direction, are held on the main part so as to be able to pivot relative to the main part about a respective pivot axis extending perpendicularly to the extension direction and perpendicularly to the spacing direction, and are movable to pivot towards one another in the extension direction into the recess to clamp the elongate component regions between the clamping fingers; and
joining the elongate component regions while clamped by the two clamping fingers.
